(19) United States
(12) Patent Application Publication
(10) Pub. No.: US 2013/0041059 A1
(43) Pub. Date: Feb. 14, 2013

(54) CURABLE COMPOSITION

(71) Applicants: Tomoyuki Torii, Takatsuki-shi (JP); Kohei Yamada, Takatsuki-shi (JP); Yoshimitsu Nakayama, Takatsuki-shi (JP); Masahiro Ito, Takatsuki-shi (JP)

(72) Inventors: Tomoyuki Torii, Takatsuki-shi (JP); Kohei Yamada, Takatsuki-shi (JP); Yoshimitsu Nakayama, Takatsuki-shi (JP); Masahiro Ito, Takatsuki-shi (JP)

(73) Assignee: Giken Kabushiki Kaisha, Takatsuki-shi (JP)

(21) Appl. No.: 13/582,529

(22) PCT Filed: Feb. 23, 2011
(86) PCT No.: PCT/JP2011/053952

§ 371 Date: Oct. 22, 2012

(30) Foreign Application Priority Data
Mar. 2, 2010 (JP) 2010-045315

(51) Int. Cl. C08L 83/16; C08K 3/22

(52) U.S. Cl. 521/141; 521/180; 521/189; 521/145; 521/146; 521/149; 521/147

(57) ABSTRACT

Disclosed is a curable composition comprising a linear hydrolyzable silyl group-containing polymer and a branched hydrolyzable silyl group-containing polymer in the weight ratio of 1:9 to 9:1 and having a specific weight of less than 1.15.

### FIELD OF THE INVENTION

The present application claims the Paris Convention priority based on Japanese Patent Application No. 2010-045315 filed on Mar. 2, 2010, the entire content of which is incorporated herein by reference.

The present invention relates to a curable composition. In particular, the present invention relates to a curable composition which has a low specific weight and exhibits an excellent rubber physical property and which is useful for a sealing material.

### BACKGROUND ART

In the past, a curable composition which is mainly composed of a hydrolyzable silyl group-containing polymer is often used as a sealing material (see, for example, Patent Documents 1-3). In recent years, a curable composition having a low specific weight is desired as the above-mentioned sealing material for reducing environmental load and improving workability.

An adhesive composition which contains a microballoon for decreasing a specific weight of a curable composition is proposed (see, for example, Patent Document 4).

However, the above-mentioned composition still has the insufficient specific weight. If the balloon amount is increased for further reducing the specific weight of the above-mentioned curable composition, the rubber physical property is deteriorated after curing, for example, the elongation is lowered and the modulus becomes high, owing to the effect of the decrease in the resin component amount per the volume of the composition and the physical property of a balloon. As a result, a sealing material performance such as flexibility to the movement of a joint and durability (or resistance to contraction and expansion) is diminished when the above-mentioned composition is used as a sealing material.

Particularly, the high level of flexibility and durability (or resistance to contraction and expansion) are required for a sealing material used since a joint in which a sealing material is applied contracts, expands, moves parallel to the wall surface and moves perpendicular to the wall surface by the effect of temperature, humidity, earthquake, wind and the like in the construction of medium- and high-rise buildings.
Patent Document 1: JP-A-06-279693
Patent Document 2: JP-A-2000-319399
Patent Document 3: JP-A-2008-50510
Patent Document 4: WO 97/05201

### SUMMARY OF THE INVENTION

An object of the present invention is to provide a curable composition which is excellent in physical properties after curing, in particular, excellent in adhesion, resistance to contraction and expansion, elongation and modulus after curing and which has a low specific weight as a whole composition and is useful for a sealing material.

The present inventors have found that the object are accomplished by a curable composition comprising a hydrolyzable silyl group-containing polymer in a range of the weight ratio of a linear hydrolyzable silyl group-containing polymer to a branched hydrolyzable silyl group-containing polymer of 1:9 to 9:1 and having a specific weight of less than 1.15. In addition, the hydrolyzable silyl group-containing polymer in the curable composition has an average silylation ratio of 75 to 100% and/or further comprises 1.5 wt. % or more, based on the weight of the curable composition, of an aliphatic hydrocarbon-based plasticizer having an epoxy group.

The present invention is intended to provide the following embodiments.

[1] A curable composition comprising
(A) a hydrolyzable silyl group-containing polymer composed of
(1) a linear hydrolyzable silyl group-containing polymer, and
(2) a branched hydrolyzable silyl group-containing polymer, wherein the weight ratio of the linear hydrolyzable silyl group-containing polymer to the branched hydrolyzable silyl group-containing polymer is in a range of 1:9 to 9:1, and
(B) a microballoon,
wherein the curable composition has a specific weight of less than 1.15 and the hydrolyzable silyl group-containing polymer (A) has an average silylation ratio of 75 to 1000 and/or the curable composition further comprises 1.5 wt. % or more, based on the weight of the curable composition, of an aliphatic hydrocarbon-based plasticizer (C) having an epoxy group.
[2] The curable composition according to [1], the hydrolyzable silyl group-containing polymer (A) has a number-average molecular weight (Mn) of 3,000 to 60,000.
[3] The curable composition according to [1] or [2], the hydrolyzable silyl group-containing polymer (A) has a molecular-weight distribution (Mw/Mn) of 1.0 to 2.0.
[4] The curable composition according to any one of [1]-[3], containing 15 to 40 wt. %, based on the weight of the curable composition, of the hydrolyzable silyl group-containing polymer (A).
[5] The curable composition according to any one of [1]-[4], wherein the hydrolyzable silyl group-containing polymer (A) is one or more polymers selected from the group consisting of a modified silicone polymer, an acrylic polymer having an alkoxysilyl group, a polyisobutylene-based polymer having an alkoxysilyl group.
[6] The curable composition according to any one of [1]-[5], wherein the microballoon (B) is a resin balloon coated with an inorganic fine powder which is treated with a titanate coupling agent or an aluminate coupling agent.
[7] The curable composition according to any one of [1]-[6], wherein the microballoon (B) has an average particle diameter of 10 to 100 μm.
[8] The curable composition according to any one of [1]-[7], wherein the microballoon (B) has a glass-transition temperature (Tg) of 50 to 200° C.
[9] The curable composition according to any one of [1]-[8], containing 0.5 to 20 wt. %, based on the weight of the curable composition, of the microballoon (B).
[10] The curable composition according to any one of [1]-[9], wherein the aliphatic hydrocarbon-based plasticizer (C) having an epoxy group is an epoxidized olefin-based plasticizer.
[11] The curable composition according to [10], wherein the epoxidized olefin-based plasticizer has 12 to 22 carbon atoms.
[12] The curable composition according to any one of [1]-[11], further comprising a modulus regulator.
[13] The curable composition according to [12], comprising 0.05 to 10 wt. %, based on the weight of the curable composition, of a modulus regulator.

### EFFECTS OF THE INVENTION

The curable composition of the invention has the low specific weight as a whole composition and is excellent in physical properties after curing, in particular, excellent in adhesion, resistance to contraction and expansion, elongation and modulus after curing. Therefore, the curable composition of the invention can be preferably used as a sealing material.

### EMBODIMENTS OF THE INVENTION

The embodiments of the invention are explained below.

The curable composition of the invention is mainly composed of a hydrolyzable silyl group-containing polymer (A). In the invention, the hydrolyzable silyl group-containing polymer (A) is composed of a linear hydrolyzable silyl group-containing polymer (1) and a branched hydrolyzable silyl group-containing polymer (2).

In said hydrolyzable silyl group-containing polymer (A), the weight ratio of the linear hydrolyzable silyl group-containing polymer (1) to the branched hydrolyzable silyl group-containing polymer (2) is selected from the range of 1:9 to 9:1, preferably, 2:8 to 8:2. When the weight ratio of the linear hydrolyzable silyl group-containing polymer (1) to the branched hydrolyzable silyl group-containing polymer (2) is in the above-mentioned range, the curable composition of the invention is excellent in physical properties, in particular, adhesion, resistance to contraction and expansion.

In the invention, the linear hydrolyzable silyl group-containing polymer refers to a hydrolyzable silyl group-containing polymer which has a linear main chain and no side chain and contains on average 2 or less of the terminal hydrolyzable silyl groups. The branched hydrolyzable silyl group-containing polymer refers to a hydrolyzable silyl group-containing polymer which has a linear main chain and one or more side chains having a hydrolyzable silyl group and contains on average more than 2 of the hydrolyzable silyl groups at the terminal and in a side chain.

The above-mentioned hydrolyzable silyl group-containing polymer (A) may have a silylation ratio of 75% or more, preferably 80% or more, more preferably 85% or more, from the viewpoint of curing property. In addition, the above-mentioned hydrolyzable silyl group-containing polymer (A) may have a silylation ratio of 100% or less, preferably 95% or less, more preferably 90% or less, from the viewpoint of resistance to contraction and expansion of a cured product.

The above-mentioned linear hydrolyzable silyl group-containing polymer (1) and the branched linear hydrolyzable silyl group-containing polymer (2) may have a silylation ratio of preferably 70% or more, more preferably 75% or more, particularly preferably 80% or more. In addition, the linear hydrolyzable silyl group-containing polymer (1) and the branched linear hydrolyzable silyl group-containing polymer (2) may have a silylation ratio of preferably 100% or less, more preferably 95% or less, particularly preferably 90% or less.

The silylation ratio can be obtained by calculating the ratio of the number of terminals in which a hydrolyzable silyl group is introduced to the number of terminals in which a hydrolyzable silyl group is not introduced, by means of nuclear magnetic resonance analysis (NMR).

In the invention, the silylation ratio of the above-mentioned hydrolyzable silyl group-containing polymer (A) is a value obtained by measuring the silylation ratio of a mixture of the linear hydrolyzable silyl group-containing polymer (1) and the branched linear hydrolyzable silyl group-containing polymer (2).

In the invention, the hydrolyzable silyl group refers to a group which has a hydroxyl or hydrolyzable group attached to a silicon atom and which may cross-link by forming a siloxane bond in a reaction catalyzed with a curing catalyst. The examples of the hydrolyzable group include, but are not particular limited to, a conventionally-known hydrolyzable group such as a hydrogen atom, a halogen atom, an alkoxy group, an acyloxy group, a ketoxymate group, an amino group, an amide group, an acid amide group, an aminooxy group, a mercapto group, an alkenyloxy group. Among them, a hydrogen atom, an alkoxy group, an acyloxy group, a ketoxymate group, an amino group, an amide group, an aminooxy group, a mercapto group and an alkenyloxy group are preferred. An alkoxy group is more preferred from the viewpoint of gentle hydrolyzability and ease in handling. A dialkoxy group is particularly preferred.

The above-mentioned hydrolyzable silyl group-containing polymer (A) used in the invention preferably has a number-average molecular weight (Mn) of 3,000 or more, more preferably 5,000 or more, from the viewpoint of physical property after curing, in particular, elongation. The above-mentioned hydrolyzable silyl group-containing polymer (A) preferably has a number-average molecular weight (Mn) of 60,000 or less, more preferably 45,000 or less, from the viewpoint of physical property, viscosity and workability.

The above-mentioned linear hydrolyzable silyl group-containing polymer (1) and the branched linear hydrolyzable silyl group-containing polymer (2) preferably have a number-average molecular weight (Mn) of 3,000 or more, more preferably 5,000 or more. The linear hydrolyzable silyl group-containing polymer (1) and the branched linear hydrolyzable silyl group-containing polymer (2) preferably have a number-average molecular weight (Mn) of 60,000 or less, more preferably 45,000 or less.

The hydrolyzable silyl group-containing polymer (A) used in the invention has a molecular-weight distribution (Mw/Mn) of 1.0 or more, preferably 1.1 or more, more preferably 1.3 or more, from the viewpoint of physical property of a cured product. On the other hand, the hydrolyzable silyl group-containing polymer (A) has a molecular-weight distribution (Mw/Mn) of 2.0 or less, preferably 1.8 or less, more preferably 1.6 or less, from the viewpoint of the physical property of a cured product.

The linear hydrolyzable silyl group-containing polymer (1) and the branched linear hydrolyzable silyl group-containing polymer (2) have a molecular-weight distribution (Mw/Mn) of 1.0 or more, preferably 1.1 or more, more preferably 1.3 or more. In addition, the linear hydrolyzable silyl group-containing polymer (1) and the branched linear hydrolyzable silyl group-containing polymer (2) have a molecular-weight distribution (Mw/Mn) of 2.0 or less, preferably 1.8 or less, more preferably 1.6 or less.

In this context, a number-average molecular weight (Mn) and an average-weight molecular weight (Mw) are polystyrene-converted values measured by gel permeation chromatography (GPC).

In the invention, the number-average molecular weight (Mn) and the weight-average molecular weight (Mw) of the hydrolyzable silyl group-containing polymer (A) are values obtained by measuring the number-average molecular weight (Mn) and the weight-average molecular weight (Mw) of a mixture of the linear hydrolyzable silyl group-containing polymer (1) and the branched linear hydrolyzable silyl group-containing polymer (2).

The examples of the linear hydrolyzable silyl group-containing polymer and the branched hydrolyzable silyl group-containing polymer include a modified silicone polymer, an acrylic polymer having an alkoxysilyl group, and a polyisobutylene-based polymer having an alkoxysilyl group. One kind or two or more kinds thereof may be used. Among them, a modified silicone polymer and/or an acrylic polymer having an alkoxysilyl group are preferred since the physical property of a curable composition can be adjusted to low modulus and high elongation, and a curable composition which has a good weather resistance and is suitable for a sealing material is obtained.

The above-mentioned modified silicone polymer refers to a liquid polymer having a polyoxyalkylene ether as a main chain and containing the above-mentioned hydrolyzable silyl group at the terminal or in a side chain. Among them, a modified silicone polymer having a polyalkylene ether such as polyoxypropylene ether as a main chain and a number-average molecular weight (Mn) of 8,000 to 45,000 is preferred.

The linear modified silicone polymer is typically commercially available, for example, as MS polymer “MS polymer S-203” from Kaneka Corporation.

In addition, the branched modified silicone polymer is typically commercially available as MS polymer “MS polymer S-810” from Kaneka Corporation.

In the curable composition of the invention, a modified silicone polymer can be used alone or in combination of two or more kinds.

The above-mentioned modified silicone polymer can be obtained, for example, according to JP-A-2002-155201, by any one of the following processes (I) to (IV):

(I) a process in which a terminal hydroxyl group of a hydroxyl group-terminated oxyalkylene polymer is converted into an unsaturated group, and then the unsaturated group is reacted with a hydrosilyl compound;
(II) a process in which a hydroxyl group-terminated oxyalkylene polymer is reacted with an isocyanate group-containing silicon compound;
(III) a process in which a terminal hydroxyl group of a hydroxyl group-terminated oxyalkylene polymer is converted into an unsaturated group, and then the unsaturated group is reacted with a mercapto group-containing silicon compound; and
(IV) a process in which a terminal hydroxyl group of a hydroxyl group-terminated oxyalkylene polymer is converted into an isocyanate group, and then the isocyanate group is reacted with an active hydrogen atom-containing silicon compound.

The above-mentioned acrylic polymer having an alkoxysilyl group refers to a polymer having a main chain composed of at least (meth)acrylic acid ester unit (if necessary, the main chain can contain a unit of a monomer copolymerizable with a (meth)acrylic acid ester unit such as C4-12 olefines, vinyl ethers, an aromatic vinyl compound, vinylsilanes and allylsilanes other than a (meth)acrylic acid ester unit) and containing an alkoxysilyl group in a molecule.

The examples of the acrylic polymer having an alkoxysilyl group used in the invention are as follows.

(i) A polymer having a number-average molecular weight (Mn) of 3,000 to 100,000 and having on average 1.2 to 3 of alkoxysilyl groups in a molecule, as disclosed in JP-B-3-80829. The polymer can be produced by radical copolymerizing (a) an acrylic acid alkyl ester (preferably, C2-4 alkyl) such as ethyl acrylate, a propyl acrylate, n-butyl acrylate, isobutyl acrylate, amyl acrylate, hexyl acrylate, 2-ethyl hexyl acrylate, cyclohexyl acrylate and n-octyl acrylate with (b) one kind selected from the group of a vinyl alkoxy silane such as vinyl trimethoxy silane, vinyl methyl dimethoxy silane, vinyl triethoxy silane and vinyl dimethyl methoxysilane and a (meta)acryloxy alkoxy silane such as γ-methacryloxypropyl trimethoxy silane and γ-methacryloxypropyl methyl dimethoxy silane or a mixture of two or more kinds thereof in the presence of (c) a mercaptoalkoxy silane such as γ-mercaptopropyl methyl dimethoxy silane and γ-mercaptopropyl trimethoxy silane as a chain transfer agent (generally, by a publicly known process such as a bulk polymerization and a solution polymerization using a polymerization initiator such as α,α′-azobis isobutyronitrile (AIBN), α,α′-azobisiso valeronitrile, benzoyl peroxide, methyl ethyl ketone peroxide or a redox polymerization process in which a redox catalyst such as a transition metal salt and an amine is combined with a peroxide-based initiator).

(ii) A polymer disclosed in JP-B-4-69667. The polymer can be produced by adding 0.05 to 50 parts by weight of an alkoxysilyl group-containing disulfide compound such as bis(trimethoxysilylmethyl)disulfide, bis(triethoxysilyl methyl)disulfide, bis(trimethoxysilylpropyl)disulfide, bis(triethoxysilylpropyl)disulfide, bis(methyldimethoxysilylmethyl)disulfide, bis(methyldiethoxysilylmethyl)disulfide, bis(propyldimethoxysilylmethyl)disulfide, bis(propyldiethoxysilylmethyl)disulfide, bis(dimethylmethoxysilylpropyl)disulfide, and bis(dimethylethoxysilylpropyl)disulfide to 100 parts by weight of a vinyl monomer, for example, an acrylate such as ethyl acrylate, butyl acrylate, 2-ethylhexyl acrylate, propyl acrylate, pentyl acrylate and stearyl acrylate; a methacrylate such as methyl methacrylate, ethyl methacrylate, butyl methacrylate, 2-ethylhexyl methacrylate, lauryl methacrylate, benzyl methacrylate and cyclohexyl methacrylate; styrene or a derivative thereof such as α-methyl styrene and chloromethyl styrene; a fumaric acid diester such as diethyl fumarate, dibutyl fumarate and dipropyl fumarate; a vinyl halide such as vinyl chloride, vinylidene chloride, ethylene fluoride, vinylidene fluoride and fluorinated vinylene, and carrying out photopolymerization (on exposure to light at normal temperature (23° C.) to 60° C. for 4 to 30 hours), if necessary, in an organic solvent such as toluene, xylene, hexane, ethyl acetate and dioctylphthalate.

In the invention, a reaction product of the above-mentioned modified silicone polymer and the acrylic polymer having an alkoxysilyl group can be used in addition to a mixture of the above-mentioned modified silicone polymer and the acrylic polymer having an alkoxysilyl group.

A mixture or reaction product of a linear modified silicone polymer and a linear acrylic polymer having an alkoxysilyl group is typically commercially available as a mixture or reaction product of a polyoxyalkylene polymer having an alkoxysilyl group and a (meth)acrylic polymer having an alkoxysilyl group such as MA903, MSX908, MSX911 and MSX943 from Kaneka Corporation.

The above-mentioned polyisobutylene-based polymer having an alkoxysilyl group refers to a polymer having a main chain composed of at least an isobutylene unit (if necessary, the main chain may contain a unit of a monomer copolymerizable with isobutylene such as C4-12 olefines, vinyl ether, an aromatic vinyl compound, vinylsilanes and allylsilanes, in addition to the isobutylene unit) and containing an alkoxysilyl group at both terminals of a molecule or in a side chain. The polyisobutylene-based polymer having an alkoxysilyl group usually has a number-average molecular weight (Mn) of 1,000 to 40,000 and is wax-like or high viscous liquid at normal temperature. In addition, the polyisobutylene-based polymer having an alkoxysilyl group can be generally produced by using an isobutylene-based polymer having a functional group at all terminals obtained by cationic polymerization called as Inifer process (see, JP-A-8-231758).

A linear polyisobutylene-based polymer having an alkoxysilyl group is typically commercially available as “Epion®” series such as “Epion® EP-505S” from Kaneka Corporation, which has a chemical structure:

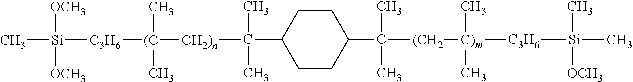

[wherein, n is from 5 to 400 and m is from 5 to 400.]

In the invention, a non-solvent type acrylic polymer having no functional group and liquid at normal temperature, which is obtained by continuous mass polymerization at high temperature and high pressure, can be compounded with a hydrolyzable silyl group-containing polymer into the curable composition of the invention. Such non-solvent type acrylic polymer which has no functional group and is liquid at normal temperature can be used to adjust the physical property of a curable composition to low modulus and high elongation and to obtain a curable composition also having good workability.

The above-mentioned non-solvent type acrylic polymer having no functional group and liquid at normal temperature can be produced, using an acrylic monomer having no functional group (for example, such an acrylate and a methacrylate as those used in polymerization of an alkoxysilyl group-containing acrylic polymer (ii)), for example, by continuous mass polymerization with a very small amount of or no initiator and with no chain transfer agent at high temperature of around 400° C. and high pressure for a very short reaction time, for example, about 5 minutes.

The above-mentioned non-solvent type acrylic polymer which has no functional group and is liquid at normal temperature has a narrow composition distribution and a narrow molecular-weight distribution, and thus, may exhibit 100% polymer, low Tg and liquid form at normal temperature and have good compatibility with a modified silicone polymer. When the above-mentioned non-solvent type acrylic polymer having no functional group and liquid at normal temperature is used, viscosity and stickiness of the curable composition can be adjusted, and workability and weather resistance may be improved. The above-mentioned non-solvent type acrylic polymer having no functional group and liquid at normal temperature is commercially available, for example, as “ARUFON° UP-1000” from TOAGOSEI corporation.

In the invention, an alkoxysilyl group-containing acrylic polymer polymerized in a modified silicone polymer is preferably used in combination with a non-solvent type acrylic polymer having no functional group and liquid at normal temperature obtained by continuous mass polymerization at high temperature and high pressure. When an alkoxysilyl group-containing acrylic polymer polymerized in a modified silicone polymer is used in combination with a non-solvent type acrylic polymer which has no functional group and is liquid at normal temperature, the effect of substituting plasticizer is obtained, the physical property of a composition after curing can be adjusted to low modulus and high elongation, and the workability and weather resistance of a curable composition may be improved.

The curable composition of the invention preferably contains 15 wt. % or more, more preferably 20 wt. % or more, based on the whole amount of the composition, of the hydrolyzable silyl group-containing polymer (A). The curable composition of the invention preferably contains 40 wt. % or less, more preferably 35 wt. % or less, based on the whole amount of the composition, of the hydrolyzable sibyl group-containing polymer (A). It is advantageous from the viewpoint of physical property, curing property, workability and cost that the curable composition of the invention contains the hydrolyzable silyl group-containing polymer (A) in the amount of the above-mentioned range.

The curable composition of the invention contains a microballoon (B) in addition to the above-mentioned hydrolyzable silyl group-containing polymer (A). The examples of the microballoon (B) include a resin balloon formed from any one of a phenol resin, an epoxy resin, a urea resin, a vinylidene chloride resin, a polystyrene resin, a styrene-based copolymer, a polymetacrylate, a polyvinyl alcohol, a vinylidene chloride-acrylonitrile copolymer, an acrylonitrile-methacrylonitrile copolymer, an acrylonitrile-methylmethacrylate copolymer and a vinylidene chloride-acrylonitrile-divinylbenzen copolymer, or an inorganic balloon such as a glass balloon. A thermally expandable microcapsule “Matsumoto Microsphere MFL100SCA” from Matsumoto Yushi-Seiyaku is preferred as a resin balloon. A resin balloon in which a part of or entire surface is coated with an inorganic fine powder is preferred. One kind or two or more kinds of calcium carbonate, a surface treated calcium carbonate, titanium oxide, silicon oxide, talc, clay and carbon black can be used as the inorganic fine powder. It is advantageous to coat the surface of a microballoon with an inorganic fine powder from the viewpoint of productivity and physical property after curing.

The above-mentioned inorganic fine powder can be also treated with a titanate-based coupling agent or an aluminate-based coupling agent. A microballoon in which the surface is coated with an inorganic fine powder treated with a titanate-based coupling agent is preferred from the viewpoint of physical property after curing.

The microballoon in which the surface is coated and which may be used in the invention preferably has a ratio of a coating material which drops from a microballoon of 50% or less, more preferably 45% or less. The microballoon in which the surface is coated and which may be used in the invention usually has a lower limit of a ratio of a coating material which drops from a microballoon of 10% or more although it is not particularly limited. The ratio of a coating material which drops from a microballoon in the above-mentioned range is advantageous from the viewpoint that deterioration of physical property after curing is prevented. The ratio of a coating material which drops from a microballoon can be obtained, for example, by the following method.

100 ml of methanol is charged into a separating funnel, and about 0.5 g of a microballoon in which the surface is coated with an inorganic fine powder is metered into the separating funnel. Then, the separating funnel is placed in a shaking apparatus, shaken for 30 seconds and then left to stand for 20 minutes. Subsequently, the precipitate is removed from the separating funnel, and then the suction filtration of the precipitate is performed and the precipitate is dried at 100° C. for 20 minutes. After that, the filter paper (glass filter) is dried at 100° C. for 20 minutes, and then the precipitate is weighed. Based on the weight of the precipitate (amount of a coating material which drops from a microballoon) and the weight of the microballoon charged (input), the ratio of a coating material which drops from a microballoon (amount of a coating material which drops from a microballoon/input) can be calculated.

The microballoon (B) used in the invention preferably has an average particle diameter of 10 μm or more, more preferably 20 μm or more. The microballoon (B) used in the invention preferably has an average particle diameter of 100 μm or less, more preferably 80 μm or less. The average particle diameter in the above-mentioned range is advantageous from the viewpoint of production cost for the curable composition of the invention, as well as pressure resistance in consideration of cost for a microballoon, and appearance. The average particle diameter refers to 50% diameter in the weight cumulative particle size distribution measured in a laser diffraction scattering particle size analyzer.

The microballoon (B) used in the invention preferably has a glass-transition temperature (Tg) of 50° C. to 200° C., more preferably 80° C. to 200° C. It is advantageous from the viewpoint of physical property and pressure resistance of a balloon that the glass-transition temperature (Tg) of the microballoon (B) used in the invention is in the above-mentioned range.

The curable composition of the invention preferably contains 0.5 wt. % or more, more preferably 2 wt. % or more, based on the whole amount of the composition, of the microballoon (B).

The curable composition of the invention preferably contains 20 wt. % or less, more preferably 15 wt. % or less of the microballoon (B). It is advantageous that the content of the microballoon (B) is 2 wt. % or more since the specific ratio of a whole composition may sufficiently decrease. In addition, it is advantageous when the content of the microballoon (B) is 20 wt. % or less since good physical property after curing is achieved.

In the invention, the curable composition may comprise the aliphatic hydrocarbon-based plasticizer having an epoxy group (C) in addition to the above-mentioned components (A) and (B) for improving the resistance to contraction and expansion of the cured product.

Examples of the above-mentioned aliphatic hydrocarbon-based plasticizer (C) having an epoxy group include an epoxidized olefin-based plasticizer. The number of carbon atoms of the epoxidized olefin-based plasticizer is preferably from 12 to 22. When the number of carbon atoms is less than 12, odor problem and loss of durability may arise. On the other hand, when the number of carbon atoms is more than 22, as a result, decrease of adhesion to an adherend, bleeding contamination and poor appearance due to precipitation at low temperature may be induced.

Specifically, examples of the above-mentioned epoxidized olefin-based plasticizer include α-olefin oxides. Such compounds may be used in the invention alone or in combination of two or more kinds as the aliphatic hydrocarbon-based plasticizer (C) having an epoxy group.

The curable composition of the invention may contain preferably at least 1.5 wt. %, more preferably at least 2.0 wt. %, particularly preferably at least 3.0 wt. %, based on the whole amount of the curable composition, of the aliphatic hydrocarbon-based plasticizer (C) having an epoxy group from the viewpoint of durability. The curable composition of the invention may contain usually 20 wt. % or less of the aliphatic hydrocarbon-based plasticizer (C) having an epoxy group in consideration of concerned lowering of the adhesion and bleeding contamination and of good appearance at low temperature.

The curable composition of the invention may optionally contain a modulus regulator, a surface treated calcium carbonate, a non-surface-treated calcium carbonate, a curing catalyst, a filler, a plasticizer and a conventionally-known additive such as a coloring agent, an organic solvent, an anti-aging agent and a tackifier in addition to the above-mentioned components (A) and (B).

Examples of the above-mentioned modulus regulator include trimethyl methoxysilane and triphenyl silanol containing a hydrolyzable monosilyl group. Among them, the triphenyl silanol is preferred since modulus of a cured product can be well adjusted. As the modulus regulator, trimethyl methoxysilane and triphenyl silanol commercially available from Dow Corning Toray Co., Ltd. may be used.

In the invention, the above-mentioned modulus regulator can be used alone or in combination of two or more kinds. The above-mentioned modulus regulator may be added to the components (A) and/or (B) prior to the preparation of the curable composition of the invention, or be added together with the components (A) and/or (B) during the preparation of the curable composition, or be added to the curable composition after the preparation.

The curable composition of the invention may contain preferably 0.05 wt. % or more, more preferably 0.1 wt. % or more, based on the whole amount of the curable composition, of a modulus regulator. The curable composition of the invention may contain preferably 10 wt. % or less, more preferably 5 wt. % or less, based on the whole amount of the curable composition, of a modulus regulator. It is advantageous from the viewpoint of the modulus reduction of a cured product that the curable composition of the invention contains a modulus regulator in the amount of the above-mentioned range.

Examples of the above-mentioned surface treated calcium carbonate include a surface treated calcium carbonate which is treated with a treating agent containing 40 wt. % or more of a fatty acid having 16 or less carbon atoms, preferably a treating agent containing 50 wt. % or more of a fatty acid having 16 or less carbon atoms, more preferably a treating agent containing 50 wt. % or more of a fatty acid having 14 or less carbon atoms, particularly preferably a treating agent containing 50 wt. % or more of a fatty acid having 14 or less carbon atoms and 15 wt. % or more of an unsaturated fatty acid having 16 or more carbon atoms, and has a treating agent amount of 3.5 wt. % or more and a BET specific surface area of 12 to 25 m²/g.

Examples of the fatty acid having 16 or less carbon atoms include butyric acid, valeric acid, caproic acid, caprylic acid, capric acid, lauric acid, myristic acid, myristoleic acid, pentadecylic acid, palmitic acid and palmitoyl acid. Among them, a saturated fatty acid is preferred since the physical property of the curable composition is maintained after thermal aging. Examples of the saturated fatty acid include butyric acid, valeric acid, caproic acid, caprylic acid, capric acid, lauric acid, myristic acid, pentadecylic acid and palmitic acid. Among them, a lauric acid and a myristic acid are preferred.

Examples of the unsaturated fatty acid having 16 or more carbon atoms include palmitoyl acid, oleic acid, linoleic acid and linoleic acid. It is advantageous from the point of improvement of workability when they are contained in the treating agent.

The treating agent amount is a value calculated by measuring the amount of an organic substance by means of thermogravimetric analysis and refers to the amount of an organic substance in a surface treated calcium carbonate. The above-mentioned treating agent amount is preferably 4.5 wt. % or more. The above-mentioned treating agent amount is preferably 7 wt. % or less, more preferably 5.5 wt. % or less. If the treating agent amount is in the above-mentioned range, the thixotropy can be sufficiently achieved.

The BET specific surface area can be obtained by a conventionally-known method, for example, a measuring method using nitrogen as an adsorption gas by means of an instrument for measuring a BET specific surface area. The BET specific surface area is preferably from 12 to 18 m²/g. When the BET specific surface is less than 12 m²/g, the thixotropy can be sufficiently achieved. On the other hand, when the BET specific surface is more than 25 m²/g, mixing may be insufficient or air is likely to be involved during mixing.

In the invention, the above-mentioned surface treated calcium carbonate may be used alone or in combination of two or more kinds.

The curable composition of the invention may contain preferably 5 wt. % or more, more preferably 10 wt. % or more, based on the whole amount of the curable composition, of the surface treated calcium carbonate. The curable composition of the invention may contain preferably 50 wt. % or less, more preferably 30 wt. % or less, based on the whole amount of the curable composition, of the surface treated calcium carbonate. It is advantageous from the viewpoint of prevention of slump by imparting thixotropy, improvement of workability and pot life that the curable composition of the invention contains the surface treated calcium carbonate in the amount of the above-mentioned range.

Examples of the above-mentioned non-surface treated calcium carbonate includes a ground calcium carbonate produced by physically grinding and classifying a weathered seashell, a rough crystalloid limestone, marble or the like by means of a dry grinding process or wet grinding process.

The non-surface treated calcium carbonate preferably has an average particle diameter of 0.05 μm or more, more preferably 0.5 μm or more, particularly preferably 1.0 μm or more. The non-surface treated calcium carbonate preferably has an average particle diameter of 5.0 μm or less, more preferably 4.5 μm or less, particularly preferably 4.0 μm or less. The average particle diameter refers to 50% diameter in a cumulative weight particle size distribution measured by a laser diffraction scattering particle size analyzer. The average particle diameter which is smaller than the above-mentioned lower limit is not desirable since the particle surface has to be treated to prevent agglomeration between particles of calcium carbonate. On the other hand, the average particle diameter which is greater than the above-mentioned upper limit is not desire from the viewpoint of degradation of rubber property after curing and thixotropy.

In the invention, the surface treated calcium carbonate may be used alone or in combination of two or more kinds.

The curable composition of the invention may contain preferably 5 wt. % or more, more preferably 15 wt. % or more, based on the whole amount of curable composition, of the non-surface treated calcium carbonate. In addition, the curable composition of the invention may contain preferably 50 wt. % or less, more preferably 40 wt. % or less, based on the whole amount of curable composition, of the non-surface treated calcium carbonate. It is advantageous from the viewpoint of workability and physical property after curing, in particular, elongation, that the curable composition of the invention contains the non-surface treated calcium carbonate in the above-mentioned range.

Examples of the curing catalyst include tin octoate, tin naphthenate, tin stearate, dibutyltin dioctoate, dibutyltin dilaurate, dioctyl tin diversatate, dibutyltin bistriethoxy silicate, dibutyltin dioleylmalate, dibutyltin diacetate, 1,1,3,3-tetrabutyl-1,3-dilauryloxycarbonyl-distannoxane, dibutyltin oxybisethoxysilicate, dibutyltin oxide, a reaction product of dibutyltin oxide and a phthalic acid ester, a reaction product of dibutyltin oxide and a maleic acid diester, and dibutyltin diacetylacetonate. Examples of other organometallic compounds include carboxylic salts (for example, octylic acid salt) of bismuth, barium, calcium, indium, titanium, zirconium, calcium, zinc, iron, cobalt and lead, for example, octyl acid bismuth, octyl acid calcium and the like. They may be used alone or in combination of two or more kinds.

Examples of the filler other than the above-mentioned surface treated calcium carbonate and the non-surface treated calcium carbonate include a calcium carbonate treated with a fatty acid, which does not correspond to the above-mentioned surface treated calcium carbonate, fumed silica, sedimentary silica, carbon black, talc, mica, clay and glass bead, balloons such as shirasu baloon, glass balloon, silica balloon, a plastic balloon and an organic powder-coated plastic balloon, a plastic particle, an inorganic fiber such as glass fiber and a metal fiber, an organic fiber such as polyethylene fiber and polypropylene fibers, boric acid aluminum, silicon carbide, silicon nitride, potassium titanate, graphite, needle crystalline calcium carbonate, boric acid magnesium, titanium diboride, chrysotile, needle crystalline filler such as wollastonite, aluminum flake, aluminum powder and iron powder. They may be used alone or in combination of two or more kinds.

As a plasticizer (thinner, viscosity modifier) other than the above-mentioned aliphatic hydrocarbon-based plasticizer (C) having an epoxy group, a publicly known hydrocarbon such as a paraffin based-, a naphthene based- and a polybutene based hydrocarbon can be used in such an amount that the ignition point, viscosity and paint adhesion are not adversely affected. In addition, phthalic acid diesters such as diisononylphthalate (DINP), epoxidized hexahydrophthalic acid diesters, alkylene dicarboxylic acid diesters and alkylbenzenes can be used in such an amount that the viscosity and paint adhesion are not adversely affected.

As other additives, a coloring agent such as colcothar, titanium oxide, carbon black, the other colored pigment and dye, an organic solvent such as acetone, methylethylketone, ligroin, ethyl acetate, tetrahydrofuran, n-hexane and heptane, a bonding agent, such as, a silane coupling agent (such as an aminosilane, a mercaptosilane and an epoxysilane), an epoxy compound and the like, a ultraviolet absorber and a light stabilizer such as benzotriazoles and hindered amines, an antioxidant such as hindered phenols, thixotropic agent such as a colloidal silica, an organic bentonite, a fatty acid amide and a hydrogenerated castor oil, a solvent such as an alicyclic hydrocarbon and an aromatic hydrocarbon can be optionally used in an appropriate amount. They can be optionally contained by a base and/or a curing agent.

The curable composition of the invention has a specific weight of the whole composition of 1.15 or less. In addition, the curable composition of the invention usually has a specific weight of the whole composition of 0.8 or more.

The curable composition of the invention after curing has an elongation of 400% or more and a 50% tensile stress of 0.25 N/mm² or less. The curable composition of the invention is preferably used as a sealing material owing to the above-mentioned specific weight, elongation and modulus.

The curable composition of the invention which is composed of the above-mentioned components may be used as one-pack type in which said components are collectively mixed, two-pack type composed of a base material containing said hydrolyzable silyl group-containing polymer and a curing agent containing a curing catalyst, or three-pack type further comprising a toner composed of a coloring agent and a plasticizer as a component other than the above-mentioned components.

When the curable composition of the invention is used as a two-pack type sealing material, the above-mentioned base and curing agent can be preferably weighed and mixed in at least one weight ratio selected from the range of 100:0.5 to 20, more preferably 100:1 to 15, particularly preferably 100:5 to 10 and cured for use.

The curable composition of the invention can be preferably used as a sealing material, more preferably a sealing material for construction of a medium- and high-rise building.

In addition, the curable composition of the invention can be applied to a car, an electric appliance, a sealing material for civil engineering and also an adhesive, a paint, a coating material, a potting material, a molding article and the like.

### Examples

The Examples of the invention will be shown below. However, the present invention is not limited thereto.

### Examples and Comparative Examples

### Base Material

The materials of weights shown in Table 1 are charged into an agitator equipped with a heating unit and a decompression unit and stirred for 30 minutes. Subsequently, mixing and stirring are conducted at 60° C. for 30 minutes and then mixing and stirring are conducted under reduced pressure for 20 minutes. After that, a base was obtained.

### Curing Agent

A curing catalyst and a calcium carbonate are mixed in the weights shown in Table 1 at room temperature. After that, a curing agent was obtained by mixing and stirring for 10 minutes.

The base and the curing agent prepared as described above were mixed at 100:10 (weight ratio) to obtain a curable composition.

TABLE 1

| | Example | | | | | | | | | | Comparative Example | | | | | |
|---|---|---|---|---|---|---|---|---|---|---|---|---|---|---|---|---|
| composition (parts by weight) | 1 | 2 | 3 | 4 | 5 | 6 | 7 | 8 | 9 | 10 | 1 | 2 | 3 | 4 | 5 | 6 |
| modified silicone polymer 1 (*1) | 90 | 20 | 10 | | | 90 | 20 | | | | | | 100 | | | |
| modified silicone polymer 2 (*2) | 10 | 80 | 90 | 90 | 80 | 10 | 80 | 10 | 10 | 15 | 50 | 10 | | 100 | 10 | 10 |
| modified silicone polymer 3 (*3) | | | | 10 | 20 | | | | | 135 | 50 | 90 | | | | |
| modified silicone polymer 4 (*4) | | | | | | | | 90 | 90 | | | | | | 90 | 90 |
| epoxy-based plasticizer 1 (*5) | 30 | 30 | 30 | 30 | 30 | 30 | 30 | 30 | 25 | 15 | 30 | 30 | 30 | 30 | 30 | 30 |
| epoxy-based plasticizer 2 (*6) | | | | | | | 15 | 15 | 20 | 15 | | | | | | 5 |
| phthalate-based plasticizer (*7) | 40 | 40 | 40 | 40 | 40 | 40 | 25 | 25 | 25 | 5 | 40 | 40 | 40 | 40 | 40 | 35 |
| alkyl benzene (*8) | 20 | 20 | 20 | 20 | 20 | 20 | 20 | 20 | 20 | 5 | 20 | 20 | 20 | 20 | 20 | 20 |
| anti-aging agent (*9) | 6 | 6 | 6 | 6 | 6 | 6 | 6 | 6 | 6 | 6 | 6 | 6 | 6 | 6 | 6 | 6 |
| castor oil-based thixotropic | 10 | 10 | 10 | 10 | 10 | 10 | 10 | 10 | 10 | 10 | 10 | 10 | 10 | 10 | 10 | 10 |
| agent (*10) | | | | | | | | | | | | | | | | |
| plastic balloon (*11) | 14 | 14 | 14 | 14 | 14 | 14 | 14 | 14 | 14 | 14 | 14 | 14 | 14 | 14 | 14 | 14 |
| fatty acid treated calcium | 80 | 80 | 80 | 80 | 80 | | 80 | 80 | 80 | 80 | 80 | 80 | 80 | 80 | 80 | 80 |
| carbonate A (*12) | | | | | | | | | | | | | | | | |
| fatty acid treated calcium | | | | | | 80 | | | | | | | | | | |
| carbonate A (*13) | | | | | | | | | | | | | | | | |
| ground calcium carbonate (*14) | 100 | 100 | 100 | 100 | 100 | 100 | 100 | 100 | 100 | 100 | 100 | 100 | 100 | 100 | 100 | 100 |
| amount of base | 400 | 400 | 400 | 400 | 400 | 400 | 400 | 400 | 400 | 400 | 400 | 400 | 400 | 400 | 400 | 400 |
| carboxylic salt of tin (*15) | 4 | 4 | 4 | 4 | 4 | 4 | 4 | 4 | 4 | 4 | 4 | 4 | 4 | 4 | 4 | 4 |
| amine compound (*16) | 1 | 1 | 1 | 1 | 1 | 1 | 1 | 1 | 1 | 1 | 1 | 1 | 1 | 1 | 1 | 1 |
| fatty acid treated calcium | 20 | 20 | 20 | 20 | 20 | 20 | 20 | 20 | 20 | 20 | 20 | 20 | 20 | 20 | 20 | 20 |
| carbonate A (*17) | | | | | | | | | | | | | | | | |
| phthalate-based plasticizer (*18) | 15 | 15 | 15 | 15 | 15 | 15 | 15 | 15 | 15 | 15 | 15 | 15 | 15 | 15 | 15 | 15 |
| amount of curing agent | 40 | 40 | 40 | 40 | 40 | 40 | 40 | 40 | 40 | 40 | 40 | 40 | 40 | 40 | 40 | 40 |
| silylation ratio of polymer (%) | 97.1 | 82.9 | 81.4 | 79.3 | 78.6 | 97.1 | 71.4 | 67.0 | 67.0 | 71.4 | 74.0 | 71.4 | 100 | 80.0 | 67.0 | 67.0 |

(*1) a silylation ratio of 90 to 100%, a linear hydrolyzable silyl group-containing polymer
(*2) a silylation ratio of 80 to 90%, a branched hydrolyzable silyl group-containing polymer
(*3) a silylation ratio of 70 to 80%, a linear hydrolyzable silyl group-containing polymer
(*4) a silylation ratio of 60 to 70%, a linear hydrolyzable silyl group-containing polymer
(*5) “SANSO CIZER E-PS” from New Japan Chemical Co., Ltd., epoxy-based plasticizer
(*6) “RIKA RESIN EX68” from New Japan Chemical Co., Ltd., epoxidized olefin plasticizer, α-olefin oxide (mixture of C16 and C18)
(*7) “DINP” from New Japan Chemical Co., Ltd.
(*8) “Alken 200P” from Nippon Oil Corporation
(*9) “Irganox 1010” from Ciba Specialty Chemicals
(*10) “DISPARLON 308” from Kusumoto Chemicals, Ltd.
(*11) resin balloon treated with a titanate-based coupling agent
(*12) “Viscolite OS” from Shiraishi Kogyo Kaisha, Ltd.
(*13) calcium carbonate treated with lauric acid 60%, oleic acid 20%
(*14) “WHITON SB” from BIHOKU FUNKA KOGYO Co., Ltd.
(*15) “NEOSTANN U-28” from NITTO KASEI Co., Ltd.
(*16) “NISSAN AMINE BB” from Nichiyu Co., Ltd.

As to each curable composition prepared as described above, the following performance test was conducted. The results are shown in Table 2.

### [Method of Performance Test]

### 1. Measurement of Specific Weight

The specific weight was measured according to JIS K 6833 5.2.1 “the specific weight cup method”.

### 2. Evaluation of Tensile Bond

A primer (name: Primer UM-2, from Sunstar Giken Co., Ltd.) was applied to A5052P aluminium board (50×50×5 mm) defined in JIS H 4000 and a curable composition prepared as described above was deposit. After curing (condition: 23±2° C.×7 days+50±2° C.×7 days), after heating (condition: after curing+90±2° C.×7 days) or after dipping in water (condition: after curing+23±2° C.×7 days in water), the 50% tensile stress [N/mm²], the maximum tensile stress [N/mm²] and the elongation [%] at maximum load were measured according to JISA1439.

### 3. Evaluation of Durability

According to JIS A 1439 5. 17 “Durability test” (2004), the test was conducted in the durability classification 9030. A judgment of good and bad is also made according to the above-mentioned standard.

◯: good, X: bad

TABLE 2

| | | | Example | | | | | | | | |
|---|---|---|---|---|---|---|---|---|---|---|---|
| | | | 1 | 2 | 3 | 4 | 5 | 6 | 7 | 8 | 9 |
| specific weight | | | 1.14 | 1.14 | 1.14 | 1.14 | 1.14 | 1.14 | 1.14 | 1.14 | 1.14 |
| H-shape | after curing | M₅₀ (N/mm²) | 0.19 | 0.10 | 0.11 | 0.19 | 0.10 | 0.19 | 0.10 | 0.08 | 0.08 |
| tensile | | Tₘₐₓ (N/mm²) | 0.38 | 0.24 | 0.25 | 0.39 | 0.23 | 0.39 | 0.23 | 0.21 | 0.21 |
| bond | | Eₘₐₓ (%) | 580 | 620 | 640 | 600 | 700 | 600 | 600 | 640 | 630 |
| | after dipping in water | M₅₀ (N/mm²) | 0.19 | 0.14 | 0.15 | 0.19 | 0.13 | 0.19 | 0.12 | 0.11 | 0.11 |
| | | Tₘₐₓ (N/mm²) | 0.40 | 0.27 | 0.28 | 0.41 | 0.27 | 0.41 | 0.27 | 0.27 | 0.29 |
| | | Eₘₐₓ (%) | 420 | 470 | 500 | 400 | 530 | 400 | 520 | 540 | 510 |
| | after heating | M₅₀ (N/mm²) | 0.20 | 0.14 | 0.15 | 0.20 | 0.13 | 0.20 | 0.14 | 0.13 | 0.15 |
| | | Tₘₐₓ (N/mm²) | 0.45 | 0.30 | 0.32 | 0.44 | 0.29 | 0.44 | 0.31 | 0.28 | 0.29 |
| | | Eₘₐₓ (%) | 460 | 430 | 460 | 500 | 480 | 500 | 440 | 500 | 490 |

| | | | | | | | | | |
|---|---|---|---|---|---|---|---|---|---|
| durability | ∘ | ∘ | ∘ | ∘ | ∘ | ∘ | ∘ | ∘ | ∘ |

| | | | Example | Comparative Example | | | | | |
|---|---|---|---|---|---|---|---|---|---|
| | | | 10 | 1 | 2 | 3 | 4 | 5 | 6 |
| specific weight | | | 1.14 | 1.14 | 1.14 | 1.14 | 1.14 | 1.14 | 1.14 |
| H-shape | after curing | M₅₀ (N/mm²) | 0.10 | 0.14 | 0.11 | 0.28 | 0.18 | 0.08 | 0.08 |
| tensile | | Tₘₐₓ (N/mm²) | 0.40 | 0.26 | 0.28 | 0.50 | 0.37 | 0.22 | 0.21 |
| bond | | Eₘₐₓ (%) | 850 | 670 | 800 | 520 | 520 | 630 | 650 |
| | after dipping in water | M₅₀ (N/mm²) | 0.12 | 0.16 | 0.13 | 0.29 | 0.16 | 0.13 | 0.11 |
| | | Tₘₐₓ (N/mm²) | 0.39 | 0.27 | 0.28 | 0.52 | 0.35 | 0.27 | 0.28 |
| | | Eₘₐₓ (%) | 620 | 380 | 540 | 390 | 500 | 550 | 520 |
| | after heating | M₅₀ (N/mm²) | 0.14 | 0.19 | 0.16 | 0.32 | 0.20 | 0.13 | 0.15 |
| | | Tₘₐₓ (N/mm²) | 0.41 | 0.25 | 0.26 | 0.57 | 0.39 | 0.29 | 0.29 |
| | | Eₘₐₓ (%) | 630 | 460 | 570 | 420 | 460 | 470 | 0.29 |

| | | | | | | | |
|---|---|---|---|---|---|---|---|
| durability | ∘ | x | x | ∘ | x | x | x |

From the above-mentioned result, a curable composition produced by using a hydrolyzable silyl group-containing polymer having the weight ratio of the linear hydrolyzable silyl group-containing polymer to the branched hydrolyzable silyl group-containing polymer in the range of 1:9 to 9:1 and a silylation ratio of 75% or more and a curable composition produced by using a hydrolyzable silyl group-containing polymer having the weight ratio of the linear hydrolyzable silyl group-containing polymer to the branched hydrolyzable silyl group-containing polymer in the range of 1:9 to 9:1 and an aliphatic hydrocarbon-based plasticizer having an epoxy group have a good physical property, in particular, a good adhesion, elongation and modulus, after curing and a specific weight of the whole composition of less than 1.15.

A curable composition in the comparative example has a good durability but is not suitable for the practical use application since the curable composition has a 50% tensile stress of 25 N/mm² or more.

1. A curable composition comprising
(A) a hydrolyzable silyl group-containing polymer composed of
(1) a linear hydrolyzable silyl group-containing polymer, and
(2) a branched hydrolyzable silyl group-containing polymer,
wherein the weight ratio of the linear hydrolyzable silyl group-containing polymer to the branched hydrolyzable silyl group-containing polymer is in a range of 1:9 to 9:1, and
(B) a microballoon,
wherein the curable composition has a specific weight of less than 1.15 and the hydrolyzable silyl group-containing polymer (A) has an average silylation ratio of 75 to 100% and/or the curable composition further comprises 1.5 wt. % or more, based on the weight of the curable composition, of an aliphatic hydrocarbon-based plasticizer (C) having an epoxy group.

2. The curable composition according to claim 1, the hydrolyzable silyl group-containing polymer (A) has a number-average molecular weight (Mn) of 3,000 to 60,000.

3. The curable composition according to claim 1, the hydrolyzable silyl group-containing polymer (A) has a molecular-weight distribution (Mw/Mn) of 1.0 to 2.0.

4. The curable composition according to claim 1, containing 15 to 40 wt. %, based on the weight of the curable composition, of the hydrolyzable silyl group-containing polymer (A).

5. The curable composition according to claim 1, wherein the hydrolyzable silyl group-containing polymer (A) is one or more polymers selected from the group consisting of a modified silicone polymer, an acrylic polymer having an alkoxysilyl group, a polyisobutylene-based polymer having an alkoxysilyl group.

6. The curable composition according to claim 1, wherein the microballoon (B) is a resin balloon coated with an inorganic fine powder which is treated with a titanate coupling agent or an aluminate coupling agent.

7. The curable composition according to claim 6, wherein the microballoon (B) has an average particle diameter of 10 to 100 μm.

8. The curable composition according to claim 6, wherein the microballoon (B) has a glass-transition temperature (Tg) of 50 to 200° C.

9. The curable composition according to claim 6, containing 0.5 to 20 wt. %, based on the weight of the curable composition, of the microballoon (B).

10. The curable composition according to claim 1, wherein the aliphatic hydrocarbon-based plasticizer (C) having an epoxy group is an epoxidized olefin-based plasticizer.

11. The curable composition according to claim 10, wherein the epoxidized olefin-based plasticizer has 12 to 22 carbon atoms.

12. The curable composition according to claim 1, further comprising a modulus regulator.

13. The curable composition according to claim 12, comprising 0.05 to 10 wt. %, based on the weight of the curable composition, of a modulus regulator.
